(19) United States
(12) Patent Application Publication
(10) Pub. No.: US 2019/0301871 A1
(43) Pub. Date: Oct. 3, 2019

(54) Direct Sparse Visual-Inertial Odometry Using Dynamic Marginalization

(71) Applicant: Artisense Corporation, Palo Alto, CA (US)

(72) Inventor: Lukas Michael von Stumberg, Munich (DE)

(21) Appl. No.: 16/366,659

(22) Filed: Mar. 27, 2019

Related U.S. Application Data
(60) Provisional application No. 62/648,416, filed on Mar. 27, 2018.

(51) Int. Cl. G01C 21/16; G06K 9/00; G06K 9/20

(52) U.S. Cl. CPC G01C 21/165; G06K 9/209; G06K 9/00664

(57) ABSTRACT

In some implementations, a visual-inertial odometry system jointly optimizes geometry data and pose data describing position and orientation. Based on camera data and inertial data, the visual-inertial odometry system uses direct sparse odometry techniques to determine the pose data and geometry data in a joint optimization. In some implementations, the visual-inertial odometry system determines the pose data and geometry data based on minimization of an energy function that includes a scale, a gravity direction, a pose, and point depths for points included in the pose and geometry data. In some implementations, the visual-inertial odometry system determines the pose data and geometry data based on a marginalization prior factor that represents a combination of camera frame data and inertial data. The visual-inertial odometry system dynamically adjusts the marginalization prior factor based on parameter estimates, such as a scale estimate.

### RELATED APPLICATIONS

The present application claims priority to U.S. provisional application No. 62/648,416 for “Direct Sparse Visual-Inertial Odometry using Dynamic Marginalization” filed Mar. 27, 2018, which is incorporated by reference herein in its entirety.

### TECHNICAL FIELD

This disclosure relates generally to the field of robotics, and more specifically relates to odometry in autonomous navigation.

### BACKGROUND

Visual odometry systems are used by a wide variety of autonomous systems, including robotic devices, self-driving cars, security monitoring systems, and other autonomous systems. In some cases, the autonomous system may drive or fly in an environment, pick up objects, or perform other interactions based on information from the visual odometry system. A visual odometry system may provide an important interface between an autonomous system and the surrounding world, enabling the autonomous system to interpret and react to objects around it. In some cases, a reliable and accurate visual odometry system may improve operation of an autonomous system, such as by improving navigational accuracy or reducing collisions.

Based on information provided by a visual odometry system, an autonomous system may perform environment interactions based on an estimated location of the autonomous system in the environment. In some cases, a visual odometry system provides the estimated location based on a scale of the environment, such as a scale indicating if a particular object is small and nearby, or large and farther away. A visual odometry system that is configured to provide high-accuracy estimations of scale or location may allow the autonomous system to avoid performing actions that could harm humans or cause property damage. In addition, a visual odometry system that is configured to rapidly initialize its estimated scale or location may enable the autonomous system to interpret the environment more quickly and to rapidly avoid harmful interactions. However, contemporary visual odometry systems may estimate or initialize visual data in separate operations from inertial data, leading to delays in optimization or discrepancies between parameters based on visual data and parameters based on inertial data.

It is desirable to develop techniques that allow a visual odometry system to provide high-accuracy estimations for visual and inertial data. In addition, it is desirable to develop techniques that allow a visual odometry system to rapidly initialize estimations for visual and inertial data.

### SUMMARY

According to certain implementations, a visual-inertial odometry system may perform a joint optimization of pose and geometry data, based on visual data and inertial data. The visual-inertial odometry system may calculate a current marginalization prior factor (“MPF”) representing a first combination of the visual data and the inertial data, a visual MPF representing the visual data and omitting representation of the inertial data, and an intermediary MPF representing a second combination of a portion of the visual data and a portion of the inertial data. The visual-inertial odometry system may determine a scale parameter based on the current MPF. Responsive to the scale parameter having a value beyond an estimate interval threshold, the visual-inertial odometry system may modify the current MPF based on the intermediary MPF, the intermediary MPF based on the visual MPF, and the scale parameter based on the modified current MPF. The visual-inertial odometry system may one or more positional parameters based on the modified scale parameter.

In some implementations, a visual-inertial odometry system may receive non-initialized values for multiple inertial parameters and non-initialized values for multiple visual parameters. The visual-inertial odometry system may determine initialized values for the multiple inertial parameters and multiple visual parameters based on an inertial error of a set of inertial measurements and a photometric error of set of camera frames. Determining the inertial and photometric errors may include generating an IMU factor describing a relation between the multiple inertial parameters, generating a visual factor describing a relation between the multiple visual parameters, and minimizing a combination of the inertial error and the photometric error based on the relations described by the IMU factor and the visual factor.

These illustrative implementations are mentioned not to limit or define the disclosure, but to provide examples to aid understanding thereof. Additional implementations are discussed in the Detailed Description, and further description is provided there.

### BRIEF DESCRIPTION OF THE DRAWINGS

Features, implementations, and advantages of the present disclosure are better understood when the following Detailed Description is read with reference to the accompanying drawings, where:

FIG. 1 is a diagram depicting an example of a visual-inertial odometry system, according to certain implementations;

FIG. 2 is a diagram depicting an example of a direct sparse odometry calculation module with a joint optimization module, that are included in a visual-inertial odometry system, according to certain implementations;

FIG. 3 is a diagram depicting an example of a direct sparse visual-inertial odometry system that includes a direct sparse odometry calculation module, a joint optimization module, a camera sensor, and an inertial measurement unit sensor, according to certain implementations;

FIG. 4 is a flow chart depicting an example of a process for determining positional parameters based on a photometric error and an inertial error, according to certain implementations;

FIG. 5 is a diagram depicting an example of a visual-inertial odometry system that is configured to initialize pose data and geometry data, according to certain implementations;

FIG. 6 (including FIGS. 6a, 6b, and 6c) includes diagrams depicting examples of factor graphs for determining mathematical relationships between parameters in a visual-inertial odometry system, according to certain implementations;

FIG. 7 depicts examples of intervals over which one or more marginalization prior factors in a visual-inertial odometry system may be calculated, according to certain implementations;

FIG. 8 is a flow chart depicting an example of a process for initializing a visual-inertial odometry system, according to certain implementations;

FIG. 9 is a flow chart depicting an example of a process for estimating a parameter based on one or more dynamically calculated marginalization prior factors, according to certain implementations; and

FIG. 10 is a block diagram depicting an example of a computing system for implementing a visual-inertial odometry system, according to certain implementations.

### DETAILED DESCRIPTION

As discussed above, contemporary visual odometry systems do not provide for joint optimization of parameters based on visual data and inertial data. In addition, contemporary visual odometry systems do not initialize visual data and inertial data jointly. Certain implementations described herein provide for a visual-inertial odometry system configured to perform joint optimization of operational parameters that are based on visual data, inertial data, or both. In addition, the visual-inertial odometry system may perform rapid initialization of operational parameters based on visual data, inertial data, or both. In some cases, the visual-inertial odometry system may perform the joint optimization or the initialization based on one or more dynamically adjusted marginalized prior factors.

The jointly optimized or initialized operational parameters may be provided to an automated system, such as a self-driving vehicle, an aerial drone, a scientific probe, or any suitable automated system that is configured to operate without human interactions. The automated system may be configured to interact with its surroundings based on the operational parameters. In some cases, parameters that are jointly optimized, such as multiple parameters that are based on one or both of visual or inertial data, may provide higher accuracy information to the automated system. Based on the higher accuracy information, the automated system may improve interactions with the surrounding environment. In addition, parameters that are rapidly initialized may provide faster feedback to the automated system, allowing the automated system to adjust its interactions more quickly. An automated system that can improve interactions with the environment may operate with improved efficiency and reliability.

In addition, a visual-inertial odometry system that is configured to rapidly initialize or to rapidly optimize a scale estimation may reduce the use of computing resources (e.g., processing power, memory). A visual-inertial odometry system that rapidly determines an accurate scale estimation based on reduced computing resources may provide additional benefits for automated systems, such as lighter-weight computing components for autonomous aerial vehicles (e.g., drones) or lower energy consumption for battery-operated devices (e.g., long-term scientific probes for interplanetary or underwater exploration).

In some implementations, a visual odometry system determines geometry data and pose data that describe the position and orientation of the visual odometry system relative to the surrounding environment. For example, a visual-inertial odometry system may receive camera data and inertial data. The camera data may include images of the surroundings of the visual-inertial odometry system. The inertial data may indicate motion of the visual-inertial odometry system. Based on the camera data and inertial data, the visual-inertial odometry system may use direct sparse odometry techniques to determine one or more of pose data or geometry data. The pose data may indicate the position and orientation of the visual-inertial odometry system based at least on visual data, such as a pose determined based on image points (e.g., points visible in an image) that are detected in the camera data. In addition, the geometry data may indicate the position and orientation of the visual-inertial odometry system based at least on non-visual data, such as geometry data determined based on gravity, distances to nearby objects, or other qualities of the environment that are not visible in a camera image. The geometry data may include a point cloud of 3D points represented in a three-dimensional (“3D”) space, such as a point cloud representing edges or surfaces of objects around the visual-inertial odometry system. For example, points in the point cloud may be associated with respective point depths, such as point depths representing distances from the visual-inertial odometry system to the point associated with a nearby object. In some implementations, one or more of the pose data or the geometry data may be based on a combination of visual and non-visual data. In some cases, the visual-inertial odometry system generates (or modifies) parameters for an autonomous system based on one or more of the pose data or the geometry data, such as parameters describing the autonomous system's position, orientation, distance to surrounding objects, scale of surrounding objects, velocity, angular velocity, navigational heading, or any other parameter related to navigation or operation of the autonomous system.

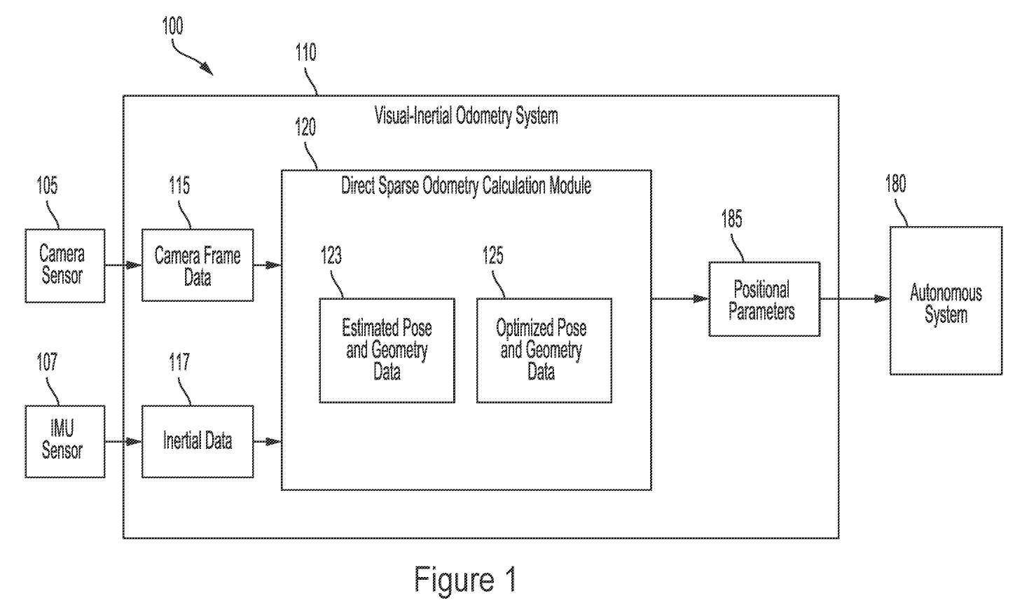

Referring now to the drawings, FIG. 1 depicts an example of a computing system 100 in which a visual-inertial odometry system 110 is implemented. For instance, the computing system 100 may be included in (or configured to communicate with) an autonomous system, such as an autonomous or semi-autonomous vehicle that is configured to navigate a surrounding environment. In some cases, the computing system 100 may be included in or communicate with a virtual autonomous system, such as a computer-implemented simulation of an autonomous system. The computing system 100 may include, for example, one or more processors or memory devices that are configured to perform operations that are described herein. In addition, the computing system 100 may include (or be configured to communicate with) one or more input devices or output devices configured to exchange information with a user, another computing system, or the surrounding environment. Input devices may be configured to provide information to the computing system 100, including input devices such as sensors (e.g., camera, accelerometer, microphone), a keyboard, a mouse, a control device (e.g., a steering wheel), or other suitable input devices. Output devices may be configured to receive information from the computing system 100, including output devices such as maneuvering devices (e.g., wheels, rotors, steering devices), alerts (e.g., lights, alarms) a display device, or other suitable output devices.

The computing system 100 includes the visual-inertial odometry system 110 and one or more sensors, such as a camera sensor 105 and an inertial measurement unit (“IMU”) sensor 107. The camera sensor 105 may be configured to provide visual data, such as digital images representing the surrounding environment of the visual-inertial odometry system 110. The visual data may include black-and-white, color, or greyscale images; still images or video sequences of images; photographic images, line images, or point-based images; or any other suitable type of visual data. The camera sensor 105 may be a monocular camera, but other implementations are possible, including stereo cameras, red-green-blue-depth (“RGB-D”) cameras, or any other suitable camera type or combination of camera types. The IMU sensor 107 may be configured to provide inertial data, such as digital measurements representing relative motion or forces (e.g., velocity, acceleration) experienced by the visual-inertial odometry system 110. The inertial data may include velocity, acceleration, angular momentum, gravity, or any other suitable type of inertial data. The IMU sensor 107 may include one or more of an accelerometer, a gyroscope, a magnetometer, or any combination of suitable measurement devices.

In some implementations, the visual-inertial odometry system 110 may receive data from the camera sensor 105, such as camera frame data 115. For example, the camera frame data 115 may include one or more camera frames that are recorded by the camera sensor 105. Each camera frame may include an image of the surroundings of the visual-inertial odometry system 110, such as images of buildings, people, road markings, or other objects in the surrounding environment. In addition, each camera frame may include (or correspond to) a time, such as a timestamp indicating when the image was recorded by the camera sensor 105. In addition, the visual-inertial odometry system 110 may receive data from the IMU sensor 107, such as inertial data 117. For example, the inertial data 117 may include one or more inertial measurements that are recorded by the IMU sensor 107. Each inertial measurement may indicate a velocity, an acceleration (including, but not limited to, gravitational acceleration), an angular velocity, an angular momentum, or other forces or motions experienced by the visual-inertial odometry system 110. In some cases, the inertial data 117 includes one or more sets of inertial measurements, such as a measurement set including a velocity, one or more accelerations and/or gravitational accelerations, an angular velocity, an angular momentum, and/or other forces or motions. In addition, each inertial measurement or measurement set may include (or correspond to) a time, such as a timestamp indicating when the measurement or measurement set was recorded by the IMU sensor 107.

In some cases, each camera frame in the camera frame data 115 corresponds to one or more measurements in the inertial data 117. For example, a particular camera frame corresponding to a particular time may be associated with a set of measurements that includes a velocity measurement, an acceleration measurement, and an angular velocity measurement that each also correspond to the particular time. In addition, the camera sensor 105 and the IMU sensor 107 may record data at different rates, such as a first rate for a camera sensor that is relatively slow (e.g., between about 10 to about 60 images per second) and a second rate for an IMU sensor that is relatively fast (e.g., between about 100 to about 200 measurements per second). In such cases, a particular camera frame may be associated with multiple measurement sets (e.g., multiple sets of velocity measurements, acceleration measurements, and angular velocity measurements) that correspond to times similar to, or within a range of, the time for the particular camera frame. For example, the camera sensor 105 may record images at a first rate that is relatively slow (e.g., 10 images per second), and the IMU sensor 107 may record measurements at a second rate that is relatively fast (e.g., 100 measurements per second). In this example, a camera frame with timestamp 0:110 (e.g., 110 milliseconds) may be associated with measurement sets with respective timestamps within a range around the camera frame's time stamp, such as measurement sets with timestamps 0:106, 0:107, 0:108, 0:109, 0:110, 0:111, 0:112, 0:113, 0:114, and 0:115. In some cases, the range may be based on a ratio between the camera sensor rate and the IMU sensor rate, such as a range of about 10 milliseconds based on a ratio between a camera sensor rate of about 10 images per second and an IMU sensor rate of about 100 measurements per second.

The visual-inertial odometry system 110 may receive one or both of the camera frame data 115 or the inertial data 117 in an ongoing manner. For example, the visual-inertial odometry system 110 may receive periodic (or semi-periodic) additions to the camera frame data 115, the inertial data 117, or both. The visual-inertial odometry system 110 may store the received data, or generate a mathematical representation of the received data, or both. For example, the visual-inertial odometry system 110 may maintain an active portion of the camera frame data 115 and an active portion of the inertial data 117. In some cases, the active data portions include recent data, such as a group of recently recorded camera frames or a group of recent measurement sets. In addition, the visual-inertial odometry system 110 may maintain a mathematical representation of non-recent data, such as a marginalization prior factor that represents data from one or both of the camera frame data 115 and the inertial data 117. Examples of data that is considered recent data include data received in a certain time span, such as the previous five minutes, or data received since a certain event, such as navigating a vehicle around a corner, but other techniques to determine recent data will be apparent to those of ordinary skill in the art.

The visual-inertial odometry system 110 may include a direct sparse odometry calculation module 120. The direct sparse odometry calculation module 120 may be configured to determine one or more of pose data or geometry data that describes a position and orientation of the visual odometry system 110 relative to the surrounding environment. For example, the direct sparse odometry calculation module 120 may calculate estimated pose and geometry data 123. The data 123 may include information describing a pose of the visual-inertial odometry system 110, such as a set of image points (e.g., extracted from one or more camera images) that indicate shapes, edges, or other visual features of the surrounding environment. In addition, the data 123 may include information describing geometry of the visual-inertial odometry system 110, such as a vector that includes values describing scale, gravity direction, velocity, IMU bias, depths of points (e.g., distances to 3D points corresponding to image points extracted from one or more camera images), or other geometry parameters for the visual-inertial odometry system 110. In some cases, point depths may be represented as inverse depths (e.g., a parameter with a value of 1/(point depth)).

The estimated pose and geometry data 123 may be calculated based on available data describing the visual-inertial odometry system 110 or the environment, such as the camera frame data 115 or the inertial data 117. In some cases, the direct sparse odometry calculation module 120 may determine the estimated pose and geometry data 123 based on data that is not included in the camera frame data 115 or the inertial data 117. For example, before or during an initialization period of the visual-inertial odometry system 110, the estimated pose and geometry data 123 may be calculated based on a non-initialized estimation of position, velocity, scale of the surrounding environment, or any other parameter. The non-initialized estimates may be based on a partial set of received data (e.g., inertial data without camera data), a default value (e.g., an assumed scale of 1.0), a value assigned by a user of the computing system 100, or other suitable data that is available before or during an initialization period of the visual-inertial odometry system 110.

The direct sparse odometry calculation module 120 may optimize the pose and geometry data for the visual-inertial odometry system 110 based on received data. Based on analysis of one or more of the camera frame data 115 or the inertial data 117, for example, the direct sparse odometry calculation module 120 may determine an adjustment for the estimated pose and geometry data 123. In some cases, the adjustment indicates a change of the visual-inertial odometry system 110's estimated position or orientation (or both). The direct sparse odometry calculation module 120 may generate optimized pose and geometry data 125 based on the determined adjustment. In some cases, the optimized pose and geometry data 125 may adjust pose and geometry data describing the position and orientation of the visual odometry system 110, such as by correcting the pose and geometry data to have a value that is closer to the actual position and orientation in the environment. In some cases, the direct sparse odometry calculation module 120 optimizes the pose and geometry data in an ongoing manner. For example, as additional camera frames and inertial measurements are added to the camera frame data 115 and the inertial data 117, the optimized pose and geometry data 125 may be included in an adjustment to the estimated geometry data 123 (e.g., as a revised estimate, as part of a history of estimates). In addition, the direct sparse odometry calculation module 120 may generate an additional optimized pose and geometry data 125, based on the adjusted estimated pose and geometry data 123, the additional camera frame data 115, and the additional inertial data 117. As further data is added to the camera frame data 115 or the inertial data 117, the direct sparse odometry calculation module 120 may further adjust the estimated and optimized data 123 and 125, such as periodic adjustments (e.g., once per millisecond) or responsive to receiving additional data for the camera frame or inertial data 115 or 117.

Based on the optimized pose and geometry data 125, the visual-inertial odometry system 110 may generate or modify one or more positional parameters 185. The positional parameters 185 may describe the pose of the visual-inertial odometry system 110, such as a position in a coordinate system or an angle of orientation. In addition, the positional parameters 185 may describe environmental factors affecting the position and location (or estimated position and location) of the visual-inertial odometry system 110, such a gravitational direction, a magnetic field, a wind speed or direction, a nautical current speed or direction, or other environmental factors. In some cases, the visual-inertial odometry system 110 is configured to provide the positional parameters 185 to an autonomous system 180. The autonomous system 180 may perform one or more operations based on the positional parameters 185, such as operations related to navigation, vehicular motion, collision avoidance, or other suitable operations.

In some cases, optimizing pose data or geometry data (or both) that are used by an autonomous system improves the capabilities of the autonomous system to interact with its environment. For example, optimization of pose and geometry data, including continuous or periodic optimization, may enable the autonomous system 180 to determine correct navigational headings, adjust velocity, estimate a correct distance to an object, or perform other adjustments to its own operations. In some cases, adjusting operations based on the optimized pose and geometry data may improve accuracy and reliability of the autonomous system's activities.

In some implementations, pose and geometry data may be optimized based on a joint optimization of multiple types of data. For example, a joint optimization technique may be performed on a data combination that includes each of camera frame data, inertial data, and an estimated pose (e.g., a previous pose estimation for a visual-inertial odometry system). The joint optimization may be performed as a bundle adjustment to all of the data that is included in the data combination. For example, a bundle adjustment may be performed on the combination of the estimated pose, estimated point cloud, camera frame data, and inertial data. In addition, the bundle adjustment may collectively adjust the multiple types of data that are included in the data combination, such as by adjusting the estimated pose, the estimated point cloud, the camera frame data, and the inertial data in a given operation or group of operations. In some cases, the joint optimization is performed based on a mathematical representation of prior data, such as one or more marginalization prior factors that represent data from a previous estimated pose, previous estimated point cloud, previous camera frame data, previous inertial data, or other prior data. A marginalization prior factor (“MPF”) may be based, in part, on a statistical marginalization technique to marginalize a portion of the prior data.

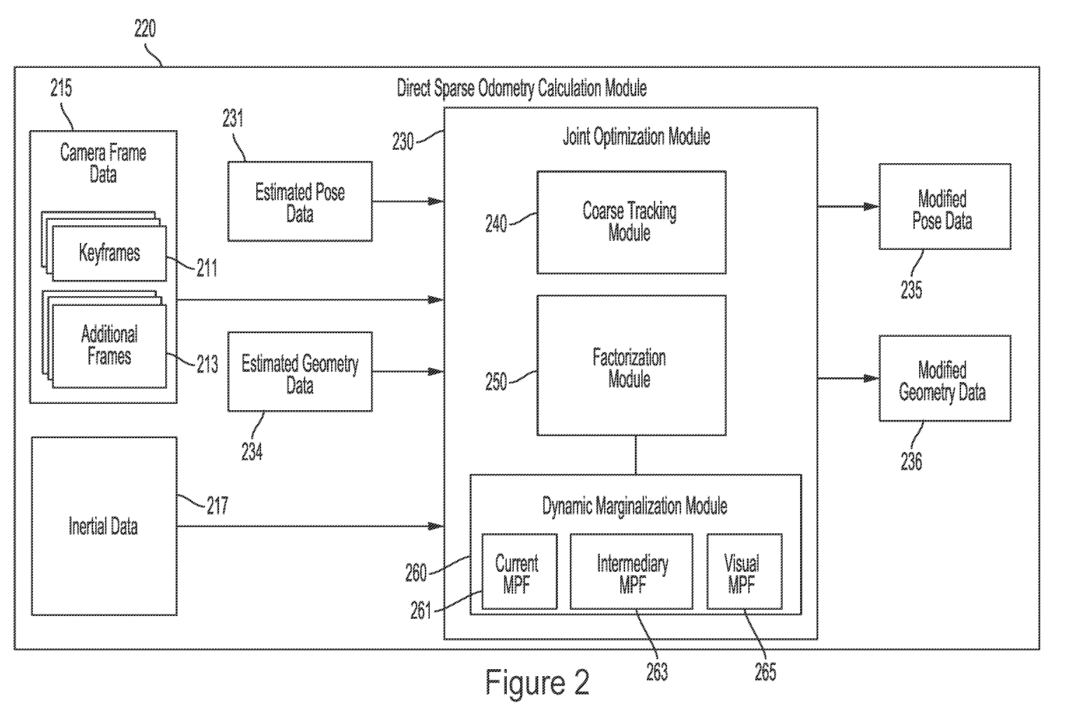

FIG. 2 depicts an example of a direct sparse odometry calculation module 220 that includes a joint optimization module 230. The direct sparse odometry calculation module 220 may be included in a visual-inertial odometry system, such as the visual-inertial odometry system 110 described in regard to FIG. 1. In addition, the direct sparse odometry calculation module 220 may receive data (e.g., as described in regard to FIG. 1), such as camera frame data 215 and inertial data 217 received from one or more sensors. In some cases, the camera frame data 215 may include one or more groups of camera frames, such as a group of keyframes 211, and a group of additional camera frames 213. Based on the received data, the joint optimization module 230 may be configured to modify one or more of pose data or geometry data. For example, the joint optimization module 230 may modify a coarse tracking adjustment to pose data based on the camera frame data 215, including the keyframes 211 and the additional frames 213. In addition, the joint optimization module 230 may perform a joint optimization of a combination of pose data and geometry data, based on the camera frame data 215 and the inertial data 217.

In some implementations, a coarse tracking module 240 that is included in the joint optimization module 230 is configured to adjust pose data based on one or more camera frames in the camera frame data 215. For example, the coarse tracking module 240 may receive estimated pose data 231, such as pose data that includes a current estimation of the visual-inertial odometry system's position and location based on visual data (e.g., a set of image points extracted from camera images). In addition, the coarse tracking module 240 may receive a current camera frame (e.g., having a timestamp indicating a recent time of recording by a camera sensor), and a current keyframe from the group of keyframes 211 (e.g., having the most recent timestamp from the group of keyframes 211). The coarse tracking module 240 may perform a comparison between the current camera frame and the current keyframe, such as a comparison based on a direct image alignment technique. In some cases, the direct sparse odometry calculation module 220 assigns the current camera frame a status as a keyframe, such as an additional keyframe included in the group of keyframes 211. For example, a current camera frame that includes a high-quality image (e.g., low blur, good illumination, clearly visible image features) may be assigned status as a keyframe.

Based on the comparison, the coarse tracking module 240 may determine an adjustment to the estimated pose data 231. The adjustment may indicate a change in the position and/or orientation of the visual-inertial odometry system, based on one or more visual differences detected between the current camera frame and the current keyframe, such as a difference between extracted points. In addition, the adjustment determined by the coarse tracking module 240 may be based on a given type of data, such as the camera frame data 215. In some cases, the joint optimization module 230 may generate modified pose data 235 based on the adjustment determined by the coarse tracking module 240, such as an adjustment that does not adjust data other than pose data.

In some implementations, the joint optimization module 230 may be configured to perform a joint optimization of a combination of pose data and geometry data. For example, a factorization module 250 that is included in the joint optimization module 230 may receive estimated geometry data 234, such as geometry data that includes a current estimation of the visual-inertial odometry system's position and location based on one or more of a point cloud, point depths, or non-visual data (e.g., a vector indicating values for inertial parameters). In addition, the factorization module 250 may receive the estimated pose data 231, some or all of the camera frame data 215 (such as the keyframes 211), and some or all of the inertial data 217. The factorization module 250 may determine a joint optimization of the estimated pose data 231 and the estimated geometry data 234, such as a joint optimization based on a non-linear optimization technique.

In some implementations, the joint optimization is determined based on one or more MPFs that represent data from one or more of previous pose data, previous geometry data, previous camera frame data, or previous inertial data. For example, a dynamic marginalization module 260 that is included in the joint optimization module 230 may determine one or more of a current MPF 261, an intermediary MPF 263, or a visual MPF 265. The MPFs 261, 263, and 265 may each represent a respective marginalized set of data, such as a set of data that includes camera frame data, or inertial data, or a combination of camera frame and inertial data. In addition, the MPFs 261, 263, and 265 may each represent a respective marginalized set of data that is associated with an interval, such as an interval of time or a scale interval. For example, if the estimated geometry data 234 indicates that the environment surrounding the visual-inertial odometry system has a scale of 1.0 (e.g., an object that appears 1.0 cm large in a camera frame is 1.0 cm large in the physical world), one or more of the MPFs 261, 263, and 265 may represent marginalized data that is within a scale interval (e.g., within an upper and lower threshold) around the scale estimate of 1.0. In addition, if the estimated scale was modified at a particular point in time (e.g., at a time t=15.0 seconds) one or more of the MPFs 261, 263, and 265 may represent marginalized data that is within a time interval since the modification of the estimated scale (e.g., between the time t=15.0 seconds and a current time). In some cases, the factorization module 250 performs a joint optimization by minimizing an energy function that includes camera frame data 215, inertial data 217, and previous camera frame and inertial data represented by the current MPF 261.

Based on the joint optimization of the estimated pose data 231 and the estimated geometry data 234, the factorization module 250 may determine a bundle adjustment to the estimated pose data 231 and the estimated geometry data 234. The bundle adjustment may indicate a change in the position and/or orientation of the visual-inertial odometry system, based on one or more differences in visual data, or non-visual data, or both. In addition, the bundle adjustment determined by the factorization module 250 may be based on multiple types of data, such as the camera frame data 215 and the inertial data 217. In some cases, the joint optimization module 230 may generate modified pose data 235 and modified geometry data 236 based on the bundle adjustment determined by the factorization module 250. The modifications may include a joint optimization, such as a joint optimization that optimizes the modified pose data 235 and the modified geometry data 236 together (e.g., in a given set of operations by the factorization module 260).

In some implementations, one or more of a joint optimization or a coarse tracking pose adjustment are performed in an ongoing manner. For example, the coarse tracking module 240 may determine a pose adjustment for each camera frame that is included in the camera frame data 215. As images are recorded by a camera sensor (such as described in regard to FIG. 1), the images may be added to the camera frame data 215 as additional camera frames (e.g., included in the additional frames 213). The coarse tracking module 240 may determine a respective pose adjustment for each added image, and generate (or modify) the modified pose data 235 based on the respective adjustments. In addition, the estimated pose data 231 may be updated based on the modified pose data 235, such that the estimated pose data 231 is kept current based on a coarse tracking pose adjustment as images are added to the camera frame data 215.

In some cases, a camera frame in the additional frames 213 is assigned status as a keyframe in the keyframes 211. For example, an additional camera frame that is determined to have high quality (e.g., by the direct sparse odometry calculation module 220) may be moved to the group of keyframes 211 as an additional keyframe. Responsive to a determination that an additional keyframe has been added, the factorization module 250 may determine a joint optimization based on the additional keyframe and on a portion of the inertial data 217 that corresponds to the additional keyframe. The factorization module 250 may determine a respective joint optimization responsive to each added keyframe, and generate (or modify) the modified pose data 235 and the modified geometry data 236 based on the respective joint optimization. In addition, the estimated pose data 231 and the estimated geometry data 234 may be updated respectively based on the modified pose data and geometry data 235 and 236, such that the estimated pose data 231 and the estimated geometry data 234 are kept current based on a joint optimization as additional keyframes are added to the camera frame data 215 or as additional measurements are added to the inertial data 217.

In some implementations, a visual-inertial odometry system is considered a direct sparse visual-inertial odometry system. The direct sparse visual-inertial odometry system may include (or be configured to communicate with) one or more of a direct sparse odometry calculation module, an IMU sensor, or a camera sensor. In addition, the direct sparse visual-inertial odometry system may determine one or more positional parameters based on pose data, geometry data, or both. In some cases, the direct sparse visual-inertial odometry system may determine the pose data and geometry data based on a minimized energy function that includes a photometric error and an inertial error. For example, the pose data and geometry data may be determined based on the photometric error of a set of points, such as changes in the position of the point between camera frames. In addition, the pose data and geometry data may be determined based on the inertial error of multiple vectors, such as changes between a state vector describing state parameters for the pose and geometry data and a prediction vector describing predicted parameters. In some cases, the direct sparse visual-inertial odometry system may determine the positional parameters based on the pose data and geometry data (or changes to the pose and geometry data) that are indicated by the photometric and inertial errors.

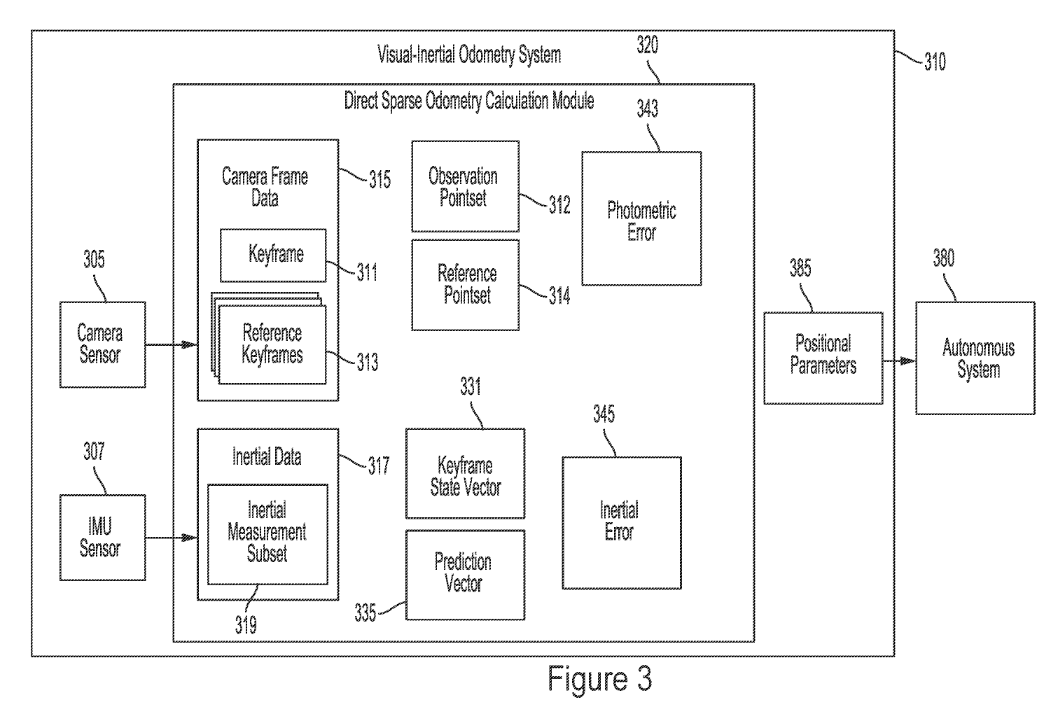

FIG. 3 depicts an example of a visual-inertial odometry system 310 that includes a direct sparse odometry calculation module 320, an IMU sensor 307, and a camera sensor 305. The visual-inertial odometry system 310 may be considered a direct sparse visual-inertial odometry system (e.g., a visual-inertial odometry system including the direct sparse odometry calculation module 320 and the IMU sensor 307). In some cases, the visual-inertial odometry system 310 may include one or more of a joint optimization module, a coarse tracking module, a factorization module, or a dynamic marginalization module (such as described in regard to FIG. 2), and these modules may perform one or more techniques described in regards to FIG. 3. The visual-inertial odometry system 310 may be configured to determine one or more positional parameters 385. Determining the positional parameters 385 may include generating a photometric error 343 and an inertial error 345, and calculating a minimized energy function based on the errors 343 and 345. In addition, the visual-inertial odometry system 310 may provide one or more of the positional parameters 385 to an autonomous system, such as an autonomous system 380.

In FIG. 3, the direct sparse odometry calculation module 320 may receive data recorded by the sensors 305 and 307, such as one or more of camera frame data 315 or inertial data 317. The camera frame data 315 may include a group of one or more camera frames, such as a keyframe 311 or an additional frame 313, that include respective images and corresponding timestamps. The inertial data 317 may include a group of one or more inertial measurements, such as an inertial measurement subset 319, and corresponding timestamps. In some cases, each of the inertial measurements (or sets of measurements) corresponds to at least one of the camera frames included in the camera frame data 315. For example, the inertial measurement subset 319 may correspond to the keyframe 311, based on inertial measurement subset 319 having a timestamp within a range timestamp of keyframe 311. In some cases, the inertial measurement subset 319 may represent multiple sets of measurements corresponding to the keyframe 311, such as a combination of multiple measurement sets that are within a time range of keyframe 311.

In some cases, the direct sparse odometry calculation module 320 may receive the keyframe 311 and a corresponding keyframe timestamp. Based on the corresponding keyframe timestamp, the direct sparse odometry calculation module 320 may determine that the keyframe 311 is a current keyframe that is included in the camera frame data 315 (e.g., the keyframe timestamp is closer to a current time than other timestamps of other keyframes). For example, the keyframe 311 may be a recently added keyframe, such as a camera frame that has had its status change to a keyframe. In some cases, responsive to determining that the keyframe 311 is the current keyframe, the direct sparse odometry calculation module 320 may generate or modify pose data and geometry data based on the keyframe 311.

The direct sparse odometry calculation module 320 may extract from the keyframe 311 a set of observation points, such as an observation pointset 312, that indicate image features visible in the keyframe 311. Non-limiting examples of image features may include edges, surfaces, shadows, colors, or other visual qualities of objects depicted in an image. In some cases, the observation pointset 312 is a sparse set of points. For example, the observation pointset 312 may include a relatively small quantity of points compared to a quantity of points that are available for extraction, such as a sparse set of approximately 100-600 extracted points for the keyframe 311, from an image having tens of thousands of points available for extraction.

In addition, the direct sparse odometry calculation module 320 may receive at least one reference camera frame from the camera frame data 315, such as the reference keyframes 313. The reference keyframes 313 may include one or more reference images and respective corresponding timestamps, such as an image that has been recorded prior to the keyframe timestamp of the keyframe 311. The direct sparse odometry calculation module 320 may extract from the reference keyframes 313 a set of reference points, such as a reference pointset 314, that indicate image features visible in the reference keyframes 313. The reference pointset 314 may be a sparse set of points, such as described above. In addition, the reference pointset 314 may include a sparse set of points for each keyframe included in the reference keyframes 313 (e.g., approximately 1000-5000 points, based on a combination of approximately 100-600 respective points for each respective reference keyframe in a group of about eight reference keyframes). In some cases, pose data, geometry data, or both may be based on one or both of the observation or reference pointsets 312 or 314. For example, the estimated or modified pose data 231 or 235 may describe poses based on extracted points (such as points from the pointsets 312 or 314). In addition, the estimated or modified geometry data 234 or 236 may include point depth information based on extracted points (such as points from the pointsets 312 or 314).

The direct sparse odometry calculation module 320 may determine the photometric error 343 based on the observation pointset 312 and reference pointset 314. For example, the direct sparse odometry calculation module 320 may compare an observed intensity of one or more points in the observation pointset 312 to a reference intensity of one or more corresponding points in the reference pointset 314. The photometric error 343 may be based on a combination of the compared intensities. In some cases, the photometric error 343 may be determined based on an equation, such as the example Equation 1.

Eₚₕₒₜₒ= [symbol] Σ_{j∈obs(p)}Eₚⱼ Eq. 1

In Equation 1, a photometric error Eₚₕₒₜₒ is determined based on a summation of photometric errors for one or more keyframes i that are included in a group of keyframes [symbol] , such as a group [symbol] including the keyframe 311 and the reference keyframes 313. In addition, the photometric error Eₚₕₒₜₒ is based on a summation of photometric errors for one or more points p in a sparse set of points [symbol] in each keyframe i. For example, a first sparse set of points [symbol] may be the observation pointset 312, and a second sparse set of points [symbol] may be a portion of the reference pointset 314 for a particular reference keyframe in the reference keyframes 313. Furthermore, the photometric error Eₚₕₒₜₒ is based on a summation of point-specific photometric errors Eₚⱼ for a group of observations for the points p in each sparse set of points [symbol] in each keyframe i. The group of observations obs(p) is based on multiple occurrences of the particular point p across a group of multiple keyframes, such as a group including the keyframe 311 and the reference keyframes 313. In some cases, a point-specific photometric error may be determined based on an equation, such as the example Equation 2.

$${E}_{pj} = {\sum }_{p ∈ {𝒩}_{p}} {ω}_{p} {‖ ( {I}_{j} [ {p}^{′} ] - {b}_{j} ) - \frac{{t}_{j} {e}^{{a}_{j}}}{{t}_{i} {e}^{{a}_{i}}} ( {I}_{i} [ p ] - {b}_{i} ) ‖}_{γ} \qquad Eq . 2$$

In Equation 2, a point-specific photometric error Eₚⱼ is determined for a particular point p, summed over a group of pixels [symbol] that is a small set of pixels around the point p. The point p is included in a first image Iᵢ. A difference of an intensity of the point p is determined between the first image Iᵢ (e.g., from the keyframe 311) and a second image Iⱼ (e.g., from a keyframe in the reference keyframes 313). The additional point p′ is a projection of the point p into the second image Iⱼ. In Equation 2, the point p belongs to a pixel group [symbol] that is a small set of pixels around the point p. In addition, tᵢ and tⱼ are respective exposure times for the first and second images Iᵢ and Iⱼ. The coefficients aᵢ and bᵢ are coefficients to correct for affine illumination changes for the first image Iᵢ and aⱼ and bⱼ are coefficients to correct for affine illumination changes for the second image Iⱼ. A Huber norm is provided by γ. A gradient-dependent weighting is provided by ωₚ.

In some cases, the direct sparse odometry calculation module 320 may determine the inertial error 345 in addition to the photometric error 343. In FIG. 3, the direct sparse odometry calculation module 320 may receive the inertial measurement subset 319 and a corresponding measurement timestamp. The inertial measurement subset 319 may correspond to the keyframe 311. In addition, the inertial measurement subset 319 may include measured values for one or more inertial parameters of the visual-inertial odometry system 310, such as measured values for one or more of gravity direction, velocity, IMU bias, or inertial other parameters. The direct sparse odometry calculation module 320 may generate (or modify) a keyframe state vector 331 based on the inertial measurement subset 319. The keyframe state vector 331 may include one or more pose parameters or geometry parameters (including, without limitation, one or more of the inertial parameters), such as scale, gravity direction, velocity, IMU bias, depths of points, or other pose or geometry parameters. In addition, the keyframe state vector 331 may include values for the parameters, such that a particular parameter of the state vector 331 is based on a respective measured value of the inertial measurement subset 319. The keyframe state vector 331 may indicate an inertial state of the visual-inertial odometry system 310 at the time of the measurement timestamp, such as at the time of the corresponding keyframe 311.

In some cases, the direct sparse odometry calculation module 320 may generate (or modify) a prediction vector 335 based on the inertial measurement subset 319. The prediction vector 335 may include predicted values for each of the pose or geometry parameters included in the keyframe state vector 331. The predicted values may be based on one or more additional camera frames, such as keyframes in the reference keyframes 313. In addition, the predicted values may be based on inertial measurements that correspond to the one or more additional camera frames, such as inertial measurements for the reference keyframes 313. For example, the direct sparse odometry calculation module 320 may determine a predicted scale (or other parameter) for the keyframe 311 based on scale measurements corresponding to previous scale measurements corresponding to at least one of the reference keyframes 313.

In some cases, pose data, geometry data, or both may be based on one or both of the state vectors 331 or 331. For example, the estimated or modified pose data 231 or 235 may describe poses based on parameter values from the state vectors 331 or 331. In addition, the estimated or modified geometry data 234 or 236 may include scale, gravity, point depth, or other geometry information based on parameter values from the state vectors 331 or 331.

The direct sparse odometry calculation module 320 may determine the inertial error 345 based on the keyframe state vector 331 and prediction vector 335. For example, the direct sparse odometry calculation module 320 may compare the value of each parameter in the keyframe state vector 331 to the respective predicted value of each parameter in the prediction vector 335 (e.g., a scale parameter compared to a predicted scale parameter, a gravity direction parameter compared to a predicted gravity direction parameter). The inertial error 345 may be based on a combination of the compared values. In some cases, the inertial error 345 may be determined based on an equation, such as Equation 3.

Eᵢₙₑᵣₜᵢₐₗ(Sᵢ,Sⱼ):=(sⱼ [symbol] ŝⱼ)^{T}\hat{Σ}_{s,j}⁻¹(sⱼ [symbol] ŝⱼ) Eq. 3

In Equation 3, an inertial error Eᵢₙₑᵣₜᵢₐₗ is determined between a state vector sⱼ, such as the keyframe state vector 331 for the keyframe 311, and an additional state vector sᵢ, such as an additional state vector for another keyframe in the reference keyframes 313. A prediction vector ŝⱼ indicates the predicted values for state vector sⱼ, and is determined based on one or more of previous camera frames or previous inertial measurements. For example, values in the prediction vector 335 may describe predicted inertial values for the keyframe 311, based on previous inertial measurements for the reference keyframes 313 (e.g., represented by the additional state vector sᵢ). The inertial error Eᵢₙₑᵣₜᵢₐₗ is determined based on a summation of differences between the state vector sⱼ and the prediction vector ŝⱼ. In some cases, a state vector (or a prediction vector) for a particular keyframe may be described by an equation, such as Equation 4.

sᵢ:=[(ξ_{cam}_{ᵢ}_{-w}^{D})^{T},vᵢ^{T},bᵢ^{T},aᵢ,bᵢ,dᵢ¹,dᵢ², . . . ,dᵢ^{m}]^{T} Eq. 4

In Equation 4, the state (or prediction) vector sᵢ includes pose parameters or geometry parameters for a keyframe i, such as the keyframe 311. Each of the parameters has one or more values (or predicted values). For example, the parameters aᵢ and bᵢ are affine illumination parameters (such as to correct affine illumination changes, as described in regard to Equation 2). The parameters dᵢ^{l} through dᵢ^{m} are inverse depths, indicating depths (e.g., distances) to points extracted from the keyframe i (e.g., distances to points in the observation pointset 312). The vector v includes velocity parameters (e.g., velocities in x, y, and z directions). The vector b includes IMU bias parameters (e.g., rotational velocities for roll, yaw, and pitch). The vector ξ_{cam}_{ᵢ}_{-w}^{D} includes a pose of the camera sensor 305, such as based on points in the keyframe 311. A superscript T indicates a transposition of a vector. Although Equation 4 is described here using keyframe 311 as an example, the vector sᵢ in Equation 4 may be used to represent a state (or prediction) for any camera frame i, including any of the reference keyframes 313.

Based on the photometric error 343 and the inertial error 345, the direct sparse odometry calculation module 320 may calculate a minimized energy function. In some cases, multiple terms in the energy function are determined in a particular operation (or set of operations), such as in a joint optimization of the photometric and inertial errors 343 and 345. In some cases, the energy function may be minimized based on one or more relational factors that describe a mathematical relationship between parameters in the state vector or prediction vector. In addition, the energy function may be minimized based on one or more MPFs that represent previous pose data or previous geometry data, such as MPFs that are received from a dynamic marginalization module. An example of an energy function is provided in Equation 5.

Eₜₒₜₐₗ=λ·Eₚₕₒₜₒ+Eᵢₙₑᵣₜᵢₐₗ Eq. 5

In Equation 5, Eₜₒₜₐₗ is a total error of geometry data and pose data that is summed based on errors determined between multiple camera frames and corresponding inertial measurements. Eₚₕₒₜₒ is a photometric error, such as the photometric error 343. In addition, Eᵢₙₑᵣₜᵢₐₗ is an inertial error, such as the inertial error 345. A factor λ represents one or more mathematical relationships between multiple parameters in the energy function (e.g., a relationship between pose and point depth, a relationship between velocity and scale).

In some implementations, one or more of pose data or geometry data, such as the modified pose data 235 and the modified geometry data 236, may be modified based on the errors 343 and 345. For example, a combination of pose data and geometry data may be jointly optimized based on a minimized energy function that includes the photometric error 343 and the inertial error 345. In some cases, the visual-inertial odometry system 310 may generate (or modify) the positional parameters 385 based on the minimized values of the photometric and inertial errors 343 and 345. The positional parameters 385 may be provided to the autonomous system 380.

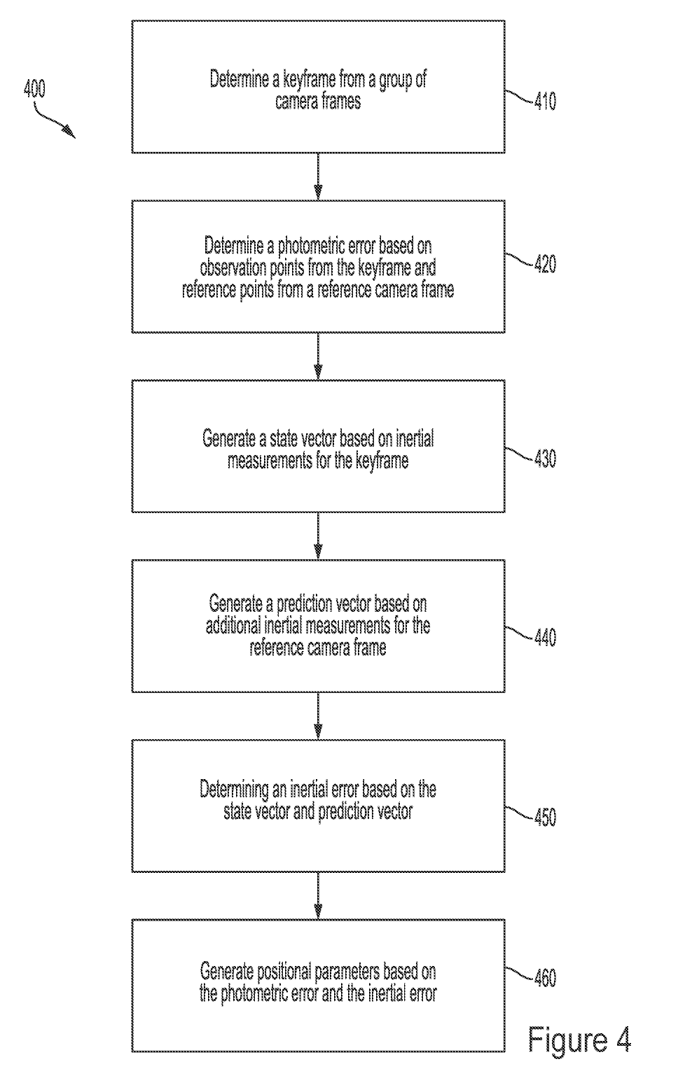

FIG. 4 is a flow chart depicting an example of a process 400 for determining positional parameters based on a photometric error and an inertial error. In some implementations, such as described in regard to FIGS. 1-3, a computing device executing a direct sparse visual-inertial odometry system implements operations described in FIG. 4, by executing suitable program code. For illustrative purposes, the process 400 is described with reference to the examples depicted in FIGS. 1-3. Other implementations, however, are possible.

At block 410, the process 400 involves determining a keyframe from a group of one or more camera frames. In some cases, the keyframe may be received from at least one camera sensor that is configured to generate visual data. For example, a direct sparse odometry calculation module, such as the direct sparse odometry calculation module 320, may determine the keyframe, such as the keyframe 311, based on a received set of camera frame data.

In some cases, the group of camera frames includes one or more reference camera frames, such as the reference keyframes 313. At block 420, the process 400 involves determining a photometric error based on a set of observation points extracted from the keyframe and a set of reference points extracted from the reference camera frame. In some cases, the set of observation points and the set of reference points may each be a sparse set of points, such as the observation pointset 312 and the reference pointset 314. In some implementations, the photometric error is based on a comparative intensity of one or more observation points as compared to respective reference points. For example, the direct sparse odometry calculation module 320 may determine the photometric error 343 based on a comparison of each observation point in the observation pointset 312 to a respective corresponding reference point in the reference pointset 314.

At block 430, the process 400 involves generating a state vector based on a first set of one or more inertial measurements. For example, the direct sparse odometry calculation module 320 may generate the keyframe state vector 331. In some cases, the state vector is based on a first camera frame, such as a keyframe. In some cases, the first set of inertial measurements corresponds to the keyframe, such as an inertial measurement subset 319 that corresponds to the keyframe 311. At block 440 the process 400 involves generating a prediction vector based on a second set of inertial measurements, such as a prediction vector indicating a predicted state corresponding to the keyframe. For example, the direct sparse odometry calculation module 320 may generate the prediction vector 335. In some cases, the prediction vector is based on a second camera frame, such as a reference camera frame. In some cases, the second set of inertial measurements corresponds to the reference camera frame, such as a subset of inertial measurements corresponding to one or more of the reference keyframes 313.

At block 450, the process 400 involves determining an inertial error based on the state vector and the prediction vector. In some cases, the inertial error is determined based on a comparison of one or more parameter values represented by the state vector and respective predicted values represented by the prediction vector. For example, the direct sparse odometry calculation module 320 may determine the inertial error 345 based on a comparison of each parameter value in the keyframe state vector 331 to a respective predicted value in the prediction vector 335.

As block 460, the process 400 involves generating one or more positional parameters based on the photometric error and the inertial error. For example, the visual-inertial odometry system 310 may generate the positional parameters 385 based on the photometric error 343 and the inertial error 345. In some cases, the positional parameters are provided to an autonomous system, such as to the autonomous system 380.

In some implementations, one or more operations in the process 400 are repeated. For example, some or all of the process 400 may be repeated based on additional camera frame or inertial data being received (or generated) by the visual-inertial odometry system. In some cases, the direct sparse odometry calculation module may perform additional comparisons of modified observation and reference pointsets and modified state and prediction vectors, such as ongoing calculations of the photometric and inertial errors based on additional camera frame data or inertial data.

### Initialization of Pose Data and Geometry Data

In some situations, a visual odometry system may undergo an initialization, such as upon powering up or following a system error (e.g., resulting in a loss of data). The initialization may last for a duration of time, such as approximately 5-10 seconds. During the initialization, the visual odometry system may lack initialized data by which to calculate the visual odometry system's current position and orientation.

In some implementations, a visual-inertial odometry system may determine pose data and geometry data during an initialization period. The pose data and geometry data may be initialized together, such as in a particular operation (or set of operations) performed by the visual-inertial odometry system. For example, a joint optimization module may receive non-initialized parameters for scale, velocity, pose, gravity directions, IMU bias, or other suitable parameters. The non-initialized parameters may be based on a partial set of received data (e.g., inertial data without camera data), a default value (e.g., an assumed scale of 1.0), a value assigned by a user of the visual-inertial odometry system, or other suitable non-initialized data that is available before or during an initialization period. The joint optimization module may determine one or more bundle adjustments for the non-initialized parameters, such as a bundle adjustment that indicates modifications to pose parameters and to geometry parameters. Based on the one or more bundle adjustments, the joint optimization module may rapidly provide initialized parameters for geometry and pose. In some cases, a visual-inertial odometry system that initializes pose parameters and geometry parameters together may omit separate initialization periods for each of geometry data and pose data.

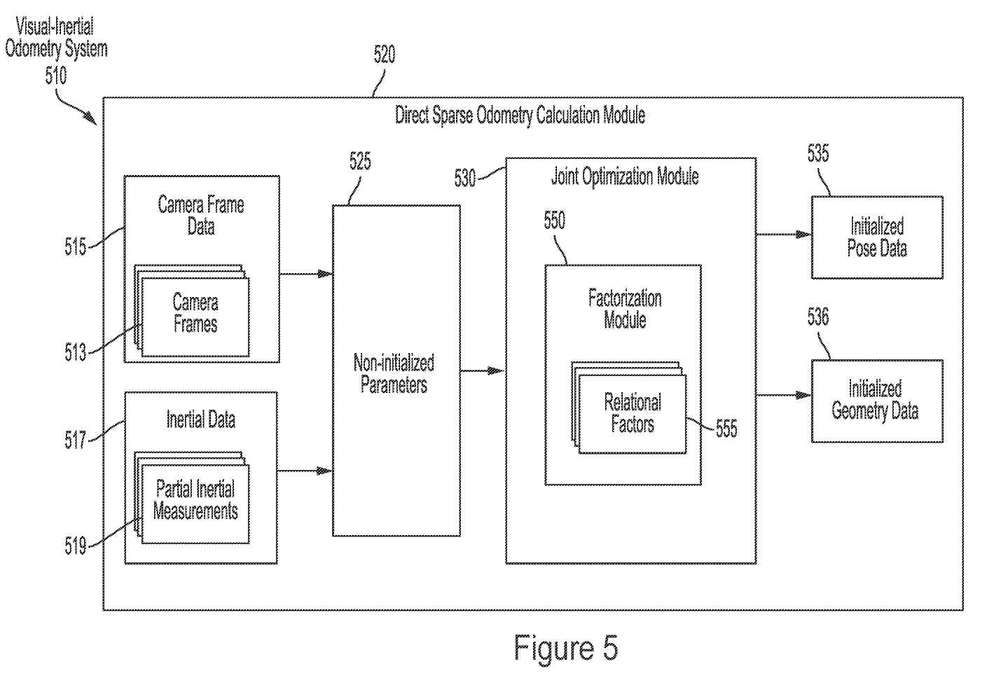

FIG. 5 depicts an example of a visual-inertial odometry system 510 that includes a direct sparse odometry calculation module 520 and a joint optimization module 530. In some cases, the visual-inertial odometry system 510 may include one or more of a coarse tracking module or a dynamic marginalization module, such as described in regard to FIG. 2. The visual-inertial odometry system 510 may be non-initialized, such as a system that has recently powered up or experienced a loss of data. In some cases, the visual-inertial odometry system 510 may have camera frame data 515 or inertial data 517 that are non-initialized. For example, one or more of the non-initialized data 515 and 517 may respectively include an empty data structure, such as a data structure that does not include a camera frame or an inertial measurement yet. In addition, one or more of the non-initialized data 515 and 517 may respectively include a quantity of data that is small relative to initialized data, such as non-initialized data including a single camera frame or a group of 40 or fewer inertial measurements.

In some implementations, the visual-inertial odometry system 510 may be in an initialization period. During the initialization period, the visual-inertial odometry system 510 may receive data from a camera sensor or IMU sensor. The received data may include a quantity of data that is insufficient to perform a complete joint optimization of pose or geometry data. For example, the visual-inertial odometry system 510 may receive a group of camera frames 513 that includes two or fewer camera frames. In addition, the visual-inertial odometry system 510 may receive a partial set of inertial measurements 519 that includes accelerometer data and omits one or more of velocity, IMU bias, scale, or gravity direction.

In some cases, one or more of the camera frames 513 or the partial inertial measurements 519 may be included in a group of non-initialized parameters 525. In addition, the direct sparse odometry calculation module 520 may determine values for one or more of the non-initialized parameters 525 based on the camera frames 513 or the partial inertial measurements 519. For example, the direct sparse odometry calculation module 520 may calculate an approximated pose based on points extracted from two camera frames in the camera frames 513. In addition, the direct sparse odometry calculation module 520 may determine approximated depths for one or more points, or may normalize the approximated depths to a default value, such as normalization to an average depth of 1 m (or 1 m⁻¹ for an inverse depth). Furthermore, the direct sparse odometry calculation module 520 may determine an approximated gravity direction, such as by averaging a small quantity of accelerometer measurements (e.g., between about 1-40 accelerometer measurements). In addition, the non-initialized parameters 525 may include one or more additional parameters having default values, or values assigned by a user of the visual-inertial odometry system 510. For example, the non-initialized parameters may include one or more of a velocity parameter having a default value (e.g., about 0 m/s), a IMU bias parameter having a default value (e.g., about 0 m/s² for accelerometer measurements, about 0 radians/s for gyroscope measurements), a scale parameter having a default value (e.g., about 1.0), or other suitable parameters.

Based on the non-initialized parameters 525, the joint optimization module 530 may perform a joint initialization of pose data and geometry data. In some cases, the joint optimization module 530 may determine a photometric error and an inertial error, such as described in regard to Equations 1-3. In addition, the joint optimization module 530 may determine at least one relational factor describing a mathematical relationship between multiple parameters described by the non-initialized parameters 525. For example, a factorization module 550 that is included in the joint optimization module 520 calculates one or more relational factors 555. The relational factors 555 may include an IMU factor that describes a mathematical relationship between the approximated values for one or more of the gravity direction, the velocity, the IMU bias, or the scale. In addition, the relational factors 555 may include a visual factor that describes a mathematical relationship between the approximated values for one or more for the pose or the point depths. In some cases, the relational factors 555 may be determined based on a factor graph technique, or one or more MPFs received from a dynamic marginalization module, or both.

In some implementations, the combination of the photometric error and inertial error is minimized, in part, based on one or more of the relational factors 555. For example, the factorization module 550 may minimize an energy function that includes the photometric error and inertial error, such as Equation 5, based on mathematical relationships between parameters represented by the energy function (e.g., mathematical relationships represented by factor λ in Equation 5). In addition, the energy function may be minimized based on one or more MPFs that represent previous pose data or previous geometry data, such as MPFs that are received from a dynamic marginalization module. In some cases, the factorization module 550 may determine the minimized combination of the photometric and inertial errors based on a partial joint optimization that is performed based on the available data in the non-initialized parameters 525.

Based on the minimized photometric error and inertial error, the joint optimization module 530 may determine initialized values for parameters in pose data, geometry data, or both. For example, the joint optimization module 530 may determine a respective value for one or more initialized parameters, such as scale, velocity, pose, gravity direction, IMU bias, or other suitable parameters. An initialized parameter may be included in one or more of initialized pose data 535 or initialized geometry data 536. In some implementations, the initialized parameters may be provided to an autonomous system that is configured to perform operations (e.g., vehicle maneuvers, collision avoidance) based on the initialized parameters. In addition, the initialized parameters may be used by the visual-inertial odometry system 510 in additional operations. For example, based on the initialized pose data 535 or initialized geometry data 536, the joint optimization module 530 may generate (or modify) estimated pose data and estimated geometry data, such as estimated pose and geometry data 231 and 234. The joint optimization module 530 may perform additional joint optimizations of the estimated pose data and estimated geometry data, such as ongoing joint optimizations described in regard to FIG. 2. Based on the rapid initialization of the combination of pose and geometry data, the visual-inertial odometry system 510 may provide optimized pose and geometry data with improved speed, improved accuracy, or both.

### Dynamic Marginalization

In some implementations, an energy function that includes a photometric error and an inertial error may be minimized based on one or more relational factors, such as the relational factors 555 described in regard to FIG. 5. The relational factors may include one or more MPFs. A dynamic marginalization module, such as the dynamic marginalization module 260 described in regard to FIG. 2, may determine the one or more MPFs. In some case, an MPF represents a mathematical relationship between parameters represented by the energy function (e.g., such as a factor λ in Equation 5). In addition, the MPF is determined based on a portion of data that includes previous visual data or previous geometry data.

In some cases, a dynamic marginalization module may calculate one or more MPFs in an ongoing manner, such as by modifying the MPF responsive to receiving data from an additional camera frame (or keyframe). In addition, the portion of data on which the MPF is calculated may dynamically change based on values of data that are received or calculated by the dynamic marginalization module. For example, the dynamic marginalization module may determine an MPF based on a portion of prior data that is related to visual data (such as a pose parameter or point depth parameters). In addition, the dynamic marginalization module may determine the MPF based on a portion of prior data that is related to inertial data (such as a scale parameter or a gravity direction parameter). Furthermore, the MPF may be determined based on a portion of prior data that is within an interval relative to the camera frame i, such as an estimate interval relative to a parameter value (e.g., scale) corresponding to the camera frame i.

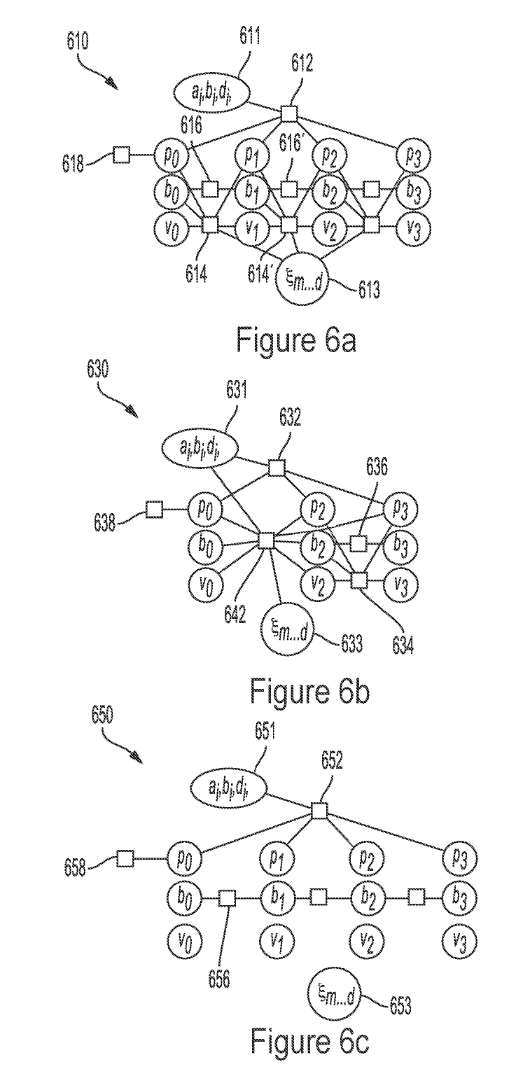

A factor graph technique may be used to determine one or more relational factors, including an MPF. FIGS. 6a through 6c (collectively referred to herein as FIG. 6) each includes a diagram depicting an example of a factor graph. In the examples depicted in FIG. 6, parameters are related based on a relational factor that describes a mathematical relationship between the parameters. In FIG. 6, a parameter is represented by a circle (or oval), and a relational factor is represented by a square. For a camera frame i received by a visual-inertial odometry system at a timestep i, the visual parameters aᵢ and bᵢ are affine illumination parameters. The visual parameter dᵢ^{l} through dᵢ^{m} are inverse depths of points 1 through m, extracted from the camera frame i. A pose parameter pᵢ describes a pose of the visual-inertial odometry system, such as the poses p₀, p₁, p₂, and p₃ for the respective camera frames. An IMU bias parameter bᵢ describes a bias of the visual-inertial odometry system at timestep i (e.g., the time of recording for the camera frame i), such as the IMU biases b₀, b₁, b₂, and b₃. A velocity parameter vᵢ describes a velocity of the visual-inertial odometry system at the timestep i, such as the velocities v₀, v₁, v₂, and v₃. A transformation parameter ξ_{m_d} describes a scale and a gravity direction of the visual-inertial odometry system at the timestep i, such as by describing a transformation between a metric reference coordinate frame and a direct sparse odometry (“DSO”) reference coordinate frame.

FIG. 6a depicts a factor graph 610 indicating an example set of relationships including visual parameters 611 and transformation parameters 613. In FIG. 6a, the visual parameters 611 are related to the pose parameters p₀, p₁, p₂, and p₃ by a visual factor 612. The transformation parameters 613 are related to the pose parameters p₀-p₃, the IMU bias parameters b₀-b₃, and the velocity parameters v₀-v₃ by one or more velocity factors, such as the velocity factors 614 or 614′. An IMU bias parameter is related to a subsequent IMU bias parameter by a respective bias factor, such as the bias factors 616 or 616′. The pose parameter p₀ is related to prior poses (such as poses corresponding to camera frames recorded at earlier times than the camera frame corresponding to pose p₀) by a prior factor 618. In some cases, such as during an initialization period, prior poses may not be available, and the prior factor 618 may include a default value, or be omitted from the factor graph 610.

FIG. 6b depicts a factor graph 630 indicating an example set of relationships including visual parameters 631 and transformation parameters 633. In FIG. 6b, the visual parameters 631 are related to the pose parameters p₀, p₂, and p₃ by a visual factor 632. The transformation parameters 633 are related to the pose parameters p₂ and p₃, the IMU bias parameters b₂ and b₃, and the velocity parameters v₂ and v₃ by one or more velocity factors, such as the velocity factor 634. An IMU bias parameter is related to a subsequent IMU bias parameter by a respective bias factor, such as the bias factor 636. The pose parameter p₀ is related to prior poses by a prior factor 638.

In addition, the factor graph 630 includes a marginalization factor 642. The marginalization factor 642 may be based, in part, on a statistical marginalization technique to marginalize a portion of data represented by the factor graph 630, such as parameters or relational factors. In the factor graph 630, the marginalization factor 642 represents parameters and relational factors corresponding to a camera frame at timestep i=1 (e.g., parameters p₁, b₁, and v₁; factors 616, 616′, 614, and 614′). In addition, the marginalization factor 642 relates the parameters 631, 633, p₀, p₂, b₀, b₂, v₀, and v₂

In some cases, the marginalization factor 642 may be an MPF, such as an MPF that marginalizes data from camera frames prior to the camera frame i (such as prior poses, prior scales, or other prior data). In addition, the marginalization factor 642 may be an MPF that is determined by a dynamic marginalization module, such as the dynamic marginalization module 260. In some cases, a dynamic marginalization module may calculate a current MPF or an intermediary MPF (such as the current MPF 261 or intermediary MPF 263 described in regard to FIG. 2) based on visual-inertial data and one or more of the factor graphs 610 or 630. In addition, the visual MPF may include marginalized visual data and marginalized inertial data (e.g., a pose parameter, point depth parameters, a scale parameter, a gravity direction parameter). In some cases, the current MPF or intermediary MPF represent scale, such as where the MPF includes one or more scale parameters in the marginalized data.

In some implementations, the portion of data on which the MPF is calculated may dynamically change based on values of data that are received or calculated by the dynamic marginalization module. For example, the dynamic marginalization module may determine the marginalization factor 642 based on a portion of prior data that is related to visual data (such as a pose parameter, point depth parameters, or affine illumination parameters). In addition, the dynamic marginalization module may determine the marginalization factor 642 based on a portion of prior data that is related to inertial data (such as a pose parameter, a scale parameter, or a gravity direction parameter).

FIG. 6c depicts a factor graph 650 indicating an example set of relationships that include visual parameters 651 and omit transformation parameters 653. In FIG. 6c, the visual parameters 651 are related to the pose parameters p₀, p₁, p₂, and p₃ by a visual factor 652. An IMU bias parameter is related to a subsequent IMU bias parameter by a respective bias factor, such as the bias factor 656. The pose parameter p₀ is related to prior poses by a prior factor 658. In the factor graph 650, relationships are not determined between the transformation parameters 653 and other parameters, or between the velocity parameters v₀-v₃ and other parameters. In some cases, a dynamic marginalization module may calculate a visual MPF (such as the visual MPF 265 described in regard to FIG. 2) based on visual data and the factor graph 650. In addition, the visual MPF may represent marginalized visual data (e.g., a portion of data including a pose parameter, point depth parameters, or affine illumination parameters) and omit marginalized inertial data (e.g., a portion of data including a scale parameter or a gravity direction parameter). In some cases, the visual MPF may be independent of scale, such as where the visual MPF omits one or more scale parameters from the marginalized data.

In some implementations, the dynamic marginalization module may calculate one or more MPFs in an ongoing manner, such as by modifying the MPF responsive to receiving data from a keyframe (or other camera frame). In addition, the portion of data on which the MPF is calculated may dynamically change based on values of data that are received or calculated by the dynamic marginalization module. The marginalization factor 642 may be determined based on a portion of prior data that is within an interval relative to the camera frame i. The interval may be based on an estimate for a parameter, such as an estimate interval relative to a parameter value (e.g., scale) corresponding to the camera frame i, or based on time, such as a time interval relative to the timestamp for the camera frame i.

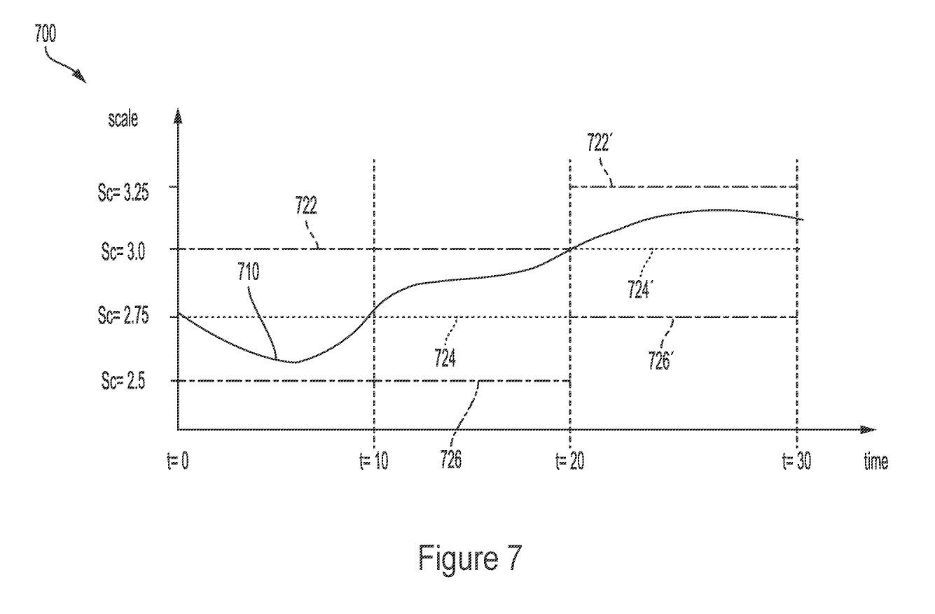

FIG. 7 depicts examples of intervals on which an MPF may be calculated. In FIG. 7, a graph 700 includes an estimate 710 for a value of a scale parameter. The scale estimate 710 may have value that is modified over time, such as via an ongoing joint optimization technique. In some cases, the scale estimate 710 is determined by a joint optimization module, such as the joint optimization module 230. In addition, the scale estimate 710 may be based in part on one or more MPFs determined by a dynamic marginalization module, such as the dynamic marginalization module 260. For example, the scale estimate 710 may be determined based on one or more of the current MPF 261, the intermediary MPF 263, or the visual MPF 265. In some implementations, the MPFs are determined based on data within an interval associated with the scale estimate 710. The interval may be an estimate interval, such as data that is within one or more thresholds associated with the scale estimate 710. In addition, the interval may be a time interval, such as data that is within a time period associated with the scale estimate 710.

In the graph 700, a joint optimization module may determine (or modify) the scale estimate 710 at an example timestamp t=0, such as based on pose and geometry data available prior to t=0 (or based on non-initialized parameters). At t=0, the scale estimate 710 may have an example value of Sc=2.75 (e.g., an object that appears 1.0 cm large in a camera frame is 2.75 cm large in the physical world). In addition, a dynamic marginalization module may determine (or modify) one or more of a current MPF, an intermediary MPF, or a visual MPF. At t=0, the dynamic marginalization module may determine one or more thresholds associated with the scale estimate 710. For example, the dynamic marginalization module may determine a midline threshold 724 based on the value of the scale estimate 710, such as a midline threshold with a value of Sc=2.75. In addition, the dynamic marginalization module may determine an upper threshold 722, based on a size of an estimate interval and the scale estimate 710. For example, if the estimate interval has a size of +/−0.25, the upper threshold 722 may have a value of Sc=3.0 (e.g., the midline value 2.75 plus 0.25). Furthermore, the dynamic marginalization module may determine a lower threshold 726 based on the estimate interval size and the scale estimate 710, such that the lower threshold 726 has a value of Sc=2.5 (e.g., the midline value 2.75 minus 0.25).

In some implementations, the dynamic marginalization module may determine the visual MPF based on data that is not associated with the scale estimate 710. For example, the dynamic marginalization module may calculate the visual MPF based on parameters from visual data (e.g., point depth parameters from camera frames) and omit parameters from inertial data (e.g., scale or gravity direction parameters from inertial measurements). In some cases, the visual MPF may be independent of scale, and may represent some information about previous states of a visual-inertial odometry system (e.g., states based on visual data without inertial data).

In addition, the dynamic marginalization module may determine the intermediary MPF based on data that is associated with one or more of the thresholds 724 or 726. Subsequent to the timestamp t=0, for instance, the dynamic marginalization module may determine the intermediary MPF based on data where the scale estimate 710 is equal to or greater than the lower threshold 726 and equal to or less than the midline threshold 724. For example, the intermediary MPF may be based on camera frames and inertial measurements that are received subsequent to the timestamp t=0, and prior to a timestamp where the scale estimate 710 crosses one of the thresholds 724 or 726. In some cases, the scale estimate 710 may be modified to have a value beyond one of the thresholds 724 or 726, such as at timestamp t=10. Responsive to determining that the scale estimate 710 has a modified value that is beyond one of the thresholds 724 or 726, the dynamic marginalization module may calculate the intermediary MPF based on visual data represented by the visual MPF. For example, the dynamic marginalization module may replace the value of the intermediary MPF at timestamp t=10 with the value of the visual MPF at timestamp t=10. Replacing the intermediary MPF with a value based on the visual MPF may provide a value that is based on scale-independent data. In some cases, the intermediary MPF may have improved accuracy based on scale-independent data, such as if the scale estimate 710 has recently crossed beyond a threshold.

In some cases, the dynamic marginalization module may determine the current MPF based on data that is associated with one or more of the thresholds 722 or 726. Subsequent to the timestamp t=0, for instance, the dynamic marginalization module may determine the current MPF based on data where the scale estimate 710 is equal to or greater than the lower threshold 726 and equal to or less than the upper threshold 722. For example, the current MPF may be based on camera frames and inertial measurements that are received subsequent to the timestamp t=0, and prior to a timestamp where the scale estimate 710 crosses one of the thresholds 722 or 726. In some cases, the scale estimate 710 may be modified to have a value beyond one of the thresholds 722 or 726, such as at timestamp t=20. Responsive to determining that the scale estimate 710 has a modified value that is beyond one of the thresholds 722 or 726, the dynamic marginalization module may calculate a modified current MPF based on a combination of visual and inertial data represented by the intermediary MPF. For example, the dynamic marginalization module may replace the value of the current MPF at timestamp t=20 with the value of the intermediary MPF at timestamp t=10.

In addition, the dynamic marginalization module may modify one or more of the thresholds 722, 724, or 726 responsive to determining that the scale estimate 710 has a modified value that is beyond one of the thresholds 722 or 726. For example, the dynamic marginalization module may determine a modified midline threshold 724′ based on the value of the scale estimate 710 at timestamp t=20, such as a value of Sc=3.0. In addition, the dynamic marginalization module may determine a modified upper threshold 722′ having a value of Sc=3.25, based on the scale estimate 710 at timestamp t=20 and the size of the estimate interval (e.g., the modified midline value 3.0 plus 0.25). Furthermore, the dynamic marginalization module may determine a modified lower threshold 726′ having a value of Sc=2.75, based on the scale estimate 710 at timestamp t=20 and the size of the estimate interval (e.g., the modified midline value 3.0 minus 0.25).

In some implementations, the dynamic marginalization module may provide the modified current MPF to the joint optimization module, and the joint optimization module may calculate additional values for the scale estimate parameter 710 based on the modified current MPF. In some cases, one or more positional parameters (such as the positional parameters 185) may be determined based on the additional scale parameter values. The positional parameters may be provided to an autonomous system (such as the autonomous system 180). In some cases, replacing the current MPF with a value based on the intermediary MPF may provide a value that is partially based on scale-independent data. If the scale estimate 710 is inconsistent in value (e.g., the value is crossing one or more thresholds), the joint optimization module may calculate subsequent values for the scale estimate 710 based on data that is partially independent of scale, such as a value from the visual MPF. In some cases, calculating the scale estimate 710 based on scale-independent data may eliminate or reduce an impact of inconsistent scale data on subsequent scale estimate values. In addition, reducing the impact of inconsistent scale data may improve the accuracy of subsequent scale estimate values, by calculating the subsequent scale estimate values based on visual data that is consistent with previous scale estimate values. In some cases, an autonomous system that receives positional parameters that are based on more accurate scale estimates may perform operations (e.g., vehicle maneuvers, collision avoidance) with improved reliability or efficiency.

In some cases, the size of the estimate interval may be dynamically adjusted based on data associated with the timestamp i at which keyframe i was marginalized. Although FIG. 7 provides an example size of 0.25, other implementations are possible. For example, the size dᵢ of the estimate interval at timestamp i may be adjusted based on a scale estimate at the timestamp i. In addition, subsequent values (e.g., at timestamp i+1) for the current MPF and intermediate MPF may be determined based on thresholds that are adjusted based on a recent scale estimate (e.g., at timestamp i).

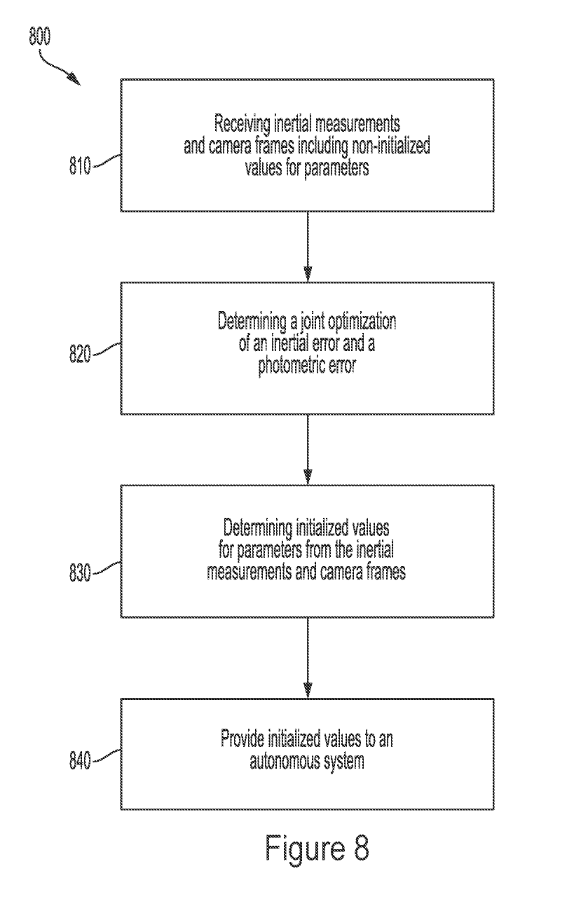

FIG. 8 is a flow chart depicting an example of a process 800 for initializing a visual-inertial odometry system. In some implementations, such as described in regard to FIGS. 1-7, a computing device executing a visual-inertial odometry system implements operations described in FIG. 8, by executing suitable program code. For illustrative purposes, the process 800 is described with reference to the examples depicted in FIGS. 1-7. Other implementations, however, are possible.

At block 810, the process 800 involves receiving a set of inertial measurements and a set of camera frames during an initialization period, such as an initialization period of a visual-inertial odometry system. In some cases, the set of inertial measurements may include a non-initialized value for multiple parameters, including a gravity direction, a velocity, an IMU bias, and a scale. In addition, the set of camera frames may include a non-initialized value for multiple parameters, including a pose and at least one point depth. In some implantations, the visual-inertial odometry system, such as the visual-inertial odometry system 510 may include one or more of the received values in a set of non-initialized parameters, such as the non-initialized parameters 525.

At block 820, the process 800 involves determining an inertial error of the set of inertial measurements and a photometric error of the set of camera frames in a joint optimization. In some implementations, the joint optimization includes minimizing a combination of the inertial error and the photometric error, such as by minimizing an energy function. The combination of the inertial error and the photometric error may be based on one or more relational factors, such as the relational factors 555. For example, a factorization module, such as the factorization module 555, may generate an IMU factor that describes a relationship between one or more of the gravity direction, the velocity, the IMU bias, and the scale included in the set of inertial measurements. In addition, the factorization module may generate a visual factor that describes a relationship between the pose and the point depth included in the set of camera frames. In some implementations, the combination of the inertial error and the photometric error may be minimized based on the relationships described by the IMU factor in the visual factor.

At block 830, the process 800 involves determining initialized values for one or more of the parameters included in the set of inertial measurements and the set of camera frames. The initialized values may include an initialized value for each of the pose, the gravity direction, the velocity, the IMU bias, and the scale. In some cases, a joint optimization module may provide one or more of initialized pose data or initialized geometry data that include (or otherwise represent) the initialized values for the parameters. For example, the joint optimization module 530 may generate the initialized pose data 535 and the initialize geometry data 536 that include respective values for one or more of the scale parameter, velocity parameter, pose parameter, point depth parameters, gravity direction parameter, and IMU bias parameter.

At block 840, the process 800 involves providing the initialized values to an autonomous system. For example, the initialized values may be included in one or more positional parameters, such as the positional parameters 185 provided to the autonomous system 180. In some cases, the autonomous system may be configured to perform operations (e.g., vehicle maneuvers, collision avoidance) based on the initialized values.

In some implementations, one or more operations in the process 800 are repeated. For example, some or all of the process 800 may be repeated based on additional camera frame or inertial data being received (or generated) by the visual-inertial odometry system. In some cases, the joint optimization module may perform additional joint optimizations based on the initialized values, such as ongoing joint optimizations based on the initialized values and additional camera frame data or inertial data.

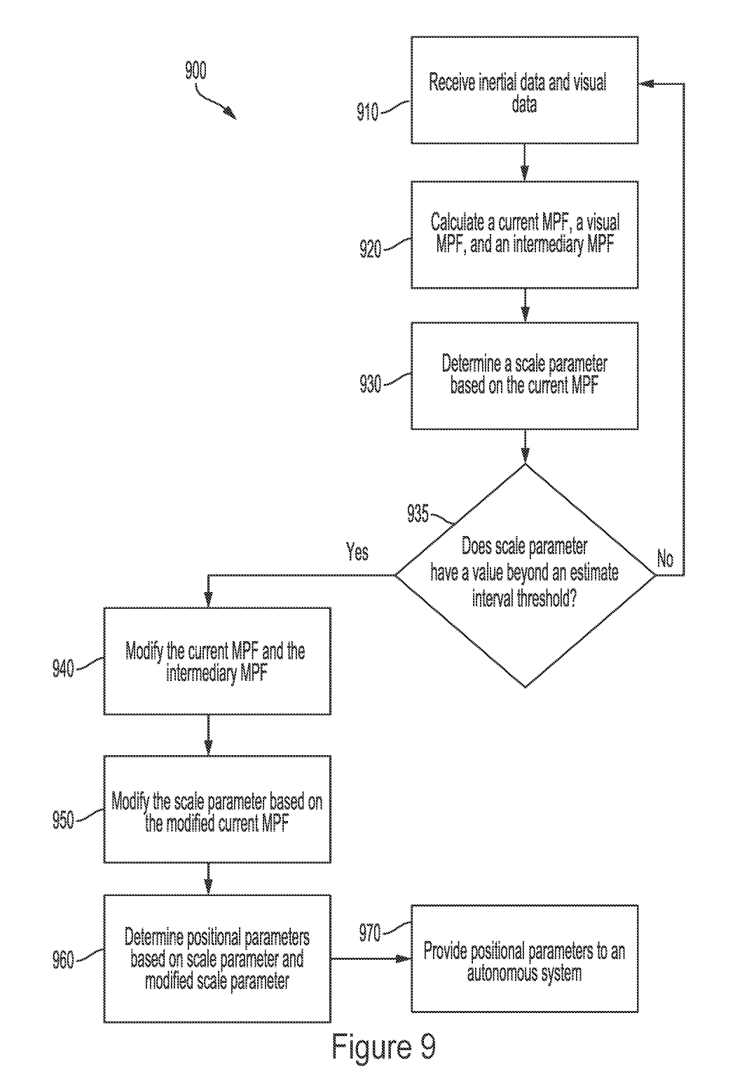

FIG. 9 is a flow chart depicting an example of a process 900 for estimating a scale parameter based on one or more dynamically calculated MPFs. In some implantations, such as described in regard to FIGS. 1-8, a computing device executing a visual-inertial odometry system implements operations described in FIG. 9, by executing suitable program code. For illustrative purposes, the process 900 is described with reference to the examples depicted in FIGS. 1-8. Other implementations, however, are possible.

At block 910, the process 900 involves receiving inertial data and visual data. For example, a visual-inertial odometry system may receive camera frame data and inertial data, such as the camera frame data 215 or inertial data 217. In addition, the visual-inertial odometry system may receive estimated pose data or estimated geometry data, such as the estimated pose or geometry data 231 and 234. In some cases, the inertial data may be based on one or more inertial measurements received from at least one IMU sensor. In addition, the visual data may be based on one or more camera frames, such as keyframes, received from at least one camera sensor.

At block 920, the process 900 involves calculating a group of MPFs, such as one or more dynamic MPFs calculated by a dynamic marginalization module. In some cases, each of the MPFs represents data from one or more of the visual data or the inertial data. The group of MPFs includes a current MPF, such as the current MPF 261, that represents a first combination including a set of the visual data and a set of the inertial data. In addition, the group of MPFs includes a visual MPF, such as the visual MPF 265, that represents the set of the visual data and omits representation of the set of the inertial data. In addition, the group of MPFs includes an intermediary MPF, such as the intermediary MPF 263, that represents a second combination including a portion of the set of visual data and a portion of the set of inertial data.

At block 930, the process 900 involves determining a scale parameter based on the current MPF. For example, a factorization module, such as the factorization module 250, may determine an estimated value for a scale parameter, such as the scale estimate 710, based on the current MPF.

At block 935, the process 900 involves determining whether the scale parameter has a value that is beyond a threshold of an estimate interval. For example, the dynamic marginalization module may determine whether the scale estimate 710 has a value that is beyond one or more of the thresholds 722 or 726. If operations related to block 935 determine that the scale parameter has a value beyond the threshold of the estimate interval, process 900 proceeds to another block such as block 940. If operations related to block 935 determine that the scale parameter has a value within a threshold of the estimate interval, process 900 proceeds to another block, such as block 910, 920, or 930.

At block 940, the process 900 involves modifying one or more of the current MPF or the intermediary MPF. In some cases, responsive to determining that the scale parameter has a value beyond a threshold of the estimate interval, the current MPF may be modified to represent the second combination of the portion of the visual data and the portion of the inertial data that is represented by the intermediary MPF. In addition, the intermediary MPF may be modified to represent the set of visual data that is represented by the visual MPF and to omit representation of the set of inertial data that is omitted by the visual MPF. For example, responsive to determining that the scale estimate 710 has a value that exceeds the threshold 722, the dynamic marginalization module 260 may assign the value of the intermediary MPF 263 to the current MPF 261, or the value of the visual MPF 265 to the intermediary MPF 263, or both.

In some cases, the process 900 involves modifying the threshold of the estimate interval. For example, responsive to determining that the scale estimate 710 has a value exceeding the threshold 722, the dynamic marginalization module 260 may modify one or more of the thresholds 722, 724, or 726.

At block 950, the process 900 involves modifying the scale parameter based on the modified current MPF. For example, the factorization module 250 may calculate an additional value for the scale estimate 710 based on the modified value of the current MPF 261.

At block 960, the process 900 involves determining one or more positional parameters, such as positional parameters that are based on one or more of the scale parameter or the modified scale parameter. The positional parameters, such as the positional parameters 185, may describe one or more of modified pose data or modified geometry data for the visual-inertial odometry system. At block 970, the process 900 involves providing the one or more positional parameters to an autonomous system, such as to the autonomous system 180.

In some implementations, one or more operations in the process 900 are repeated. For example, some or all of the process 900 may be repeated based on additional visual or inertial data being received by the visual-inertial odometry system. In some cases, operations related to calculating one or more MPFs, determining the scale parameter, comparing the scale parameter to one or more of the thresholds, or modifying one or more of the thresholds may be repeated in an ongoing manner.

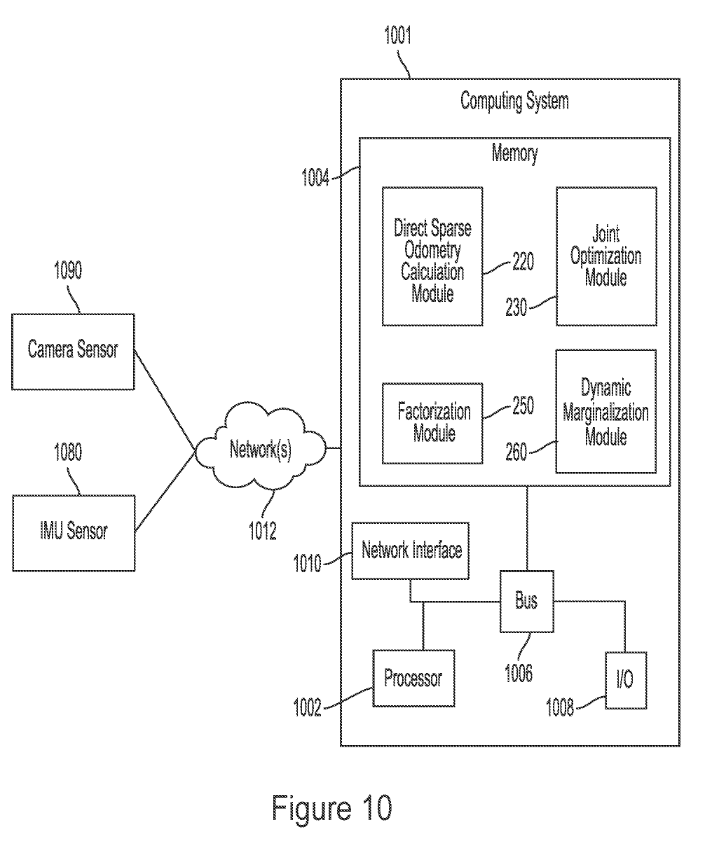

Any suitable computing system or group of computing systems can be used for performing the operations described herein. For example, FIG. 10 is a block diagram depicting a computing system 1001 that is configured as a visual-inertial odometry system, according to certain implementations.

The depicted example of a computing system 1001 includes one or more processors 1002 communicatively coupled to one or more memory devices 1004. The processor 1002 executes computer-executable program code or accesses information stored in the memory device 1004. Examples of processor 1002 include a microprocessor, an application-specific integrated circuit (“ASIC”), a field-programmable gate array (“FPGA”), or other suitable processing device. The processor 1002 can include any number of processing devices, including one.

The memory device 1004 includes any suitable non-transitory computer-readable medium for storing the direct sparse odometry calculation module 220, the joint optimization module 230, the factorization module 250, the dynamic marginalization module 260, and other received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 1001 may also include a number of external or internal devices such as input or output devices. For example, the computing system 1001 is shown with an input/output (“I/O”) interface 1008 that can receive input from input devices or provide output to output devices. A bus 1006 can also be included in the computing system 1001. The bus 1006 can communicatively couple one or more components of the computing system 1001.

The computing system 1001 executes program code that configures the processor 1002 to perform one or more of the operations described above with respect to FIGS. 1-9. The program code includes operations related to, for example, one or more of the direct sparse odometry calculation module 220, the joint optimization module 230, the factorization module 250, the dynamic marginalization module 260, or other suitable applications or memory structures that perform one or more operations described herein. The program code may be resident in the memory device 1004 or any suitable computer-readable medium and may be executed by the processor 1002 or any other suitable processor. In some implementations, the program code described above, the direct sparse odometry calculation module 220, the joint optimization module 230, the factorization module 250, and the dynamic marginalization module 260 are stored in the memory device 1004, as depicted in FIG. 10. In additional or alternative implementations, one or more of the direct sparse odometry calculation module 220, the joint optimization module 230, the factorization module 250, the dynamic marginalization module 260, and the program code described above are stored in one or more memory devices accessible via a data network, such as a memory device accessible via a cloud service.

The computing system 1001 depicted in FIG. 10 also includes at least one network interface 1010. The network interface 1010 includes any device or group of devices suitable for establishing a wired or wireless data connection to one or more data networks 1012. Non-limiting examples of the network interface 1010 include an Ethernet network adapter, a modem, and/or the like. In some cases, the computing system 1001 is able to communicate with one or more of a camera sensor 1090 or an IMU sensor 1080 using the network interface 1010. Although FIG. 10 depicts the sensors 1090 and 1080 as connected to computing system 1001 via the networks 1012, other implementations are possible, including the sensors 1090 and 1080 operating as components of computing system 1001, such as input components connected via I/O interface 1008.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific implementations thereof, it will be appreciated that those skilled in the art, upon attaining an understanding of the foregoing, may readily produce alterations to, variations of, and equivalents to such implementations. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A visual-inertial odometry system comprising:
a dynamic marginalization module configured to perform:
calculating a group of marginalization prior factors, wherein each marginalization prior factor (MPF) represents data from a set of visual data or data from a set of inertial data, wherein the group of marginalization prior factors includes (i) a current MPF that represents a first combination of the set of the visual data and the set of the inertial data, (ii) a visual MPF that represents the set of the visual data, wherein the visual MPF omits representation of the set of the inertial data, and (iii) an intermediary MPF that represents a second combination of a portion of the set of the visual data and a portion of the set of the inertial data,
determining a scale parameter based on the current MPF,
modifying, responsive to the scale parameter having a value beyond a threshold of an estimate interval:
the current MPF to represent the portion of the visual data and the portion of the inertial data that are represented by the intermediary MPF,
the intermediary MPF to represent the set of the visual data that is represented by the visual MPF and to omit representation of the set of the inertial data that is omitted by the visual MPF, and
the scale parameter based on the modified current MPF, and
determining additional values for the modified scale parameter based on the modified current MPF; and
a joint optimization module configured to perform:
determining, based on the modified scale parameter, one or more positional parameters; and
providing the one or more positional parameters to an autonomous system.

2. The visual-inertial odometry system of claim 1, wherein the dynamic marginalization module is further configured for, responsive to the scale parameter having a first value beyond a midline threshold, modifying the intermediary MPF to represent the set of the visual data that is represented by the visual MPF.

3. The visual-inertial odometry system of claim 1, wherein the dynamic marginalization module is further configured for, responsive to the scale parameter having the value beyond the threshold of the estimate interval, modifying the threshold of the estimate interval.

4. The visual-inertial odometry system of claim 1, wherein the joint optimization module is further configured for receiving the set of inertial data from an inertial measurement unit (IMU), and receiving the set of visual data from a camera sensor.

5. The visual-inertial odometry system of claim 1, further comprising a factorization module configured to perform:
minimizing an energy function based on the current MPF; and
determining, based on the minimized energy function, a bundle adjustment to the one or more positional parameters.

6. The visual-inertial odometry system of claim 1, wherein the set of inertial data includes a transformation parameter describing a scale value and a gravity direction value.

7. A method of estimating a scale parameter in a visual-inertial odometry system, the method comprising operations performed by one or more processors, the operations comprising:
calculating a group of marginalization prior factors, wherein each marginalization prior factor (MPF) represents data from a set of visual data or data from a set of inertial data, wherein the group of marginalization prior factors includes (i) a current MPF that represents a first combination of a set of the visual data and a set of the inertial data, (ii) a visual MPF that represents the set of the visual data, wherein the visual MPF omits representation of the set of the inertial data, and (iii) an intermediary MPF that represents a second combination of a portion of the set of the visual data and a portion of the set of the inertial data;
determining the scale parameter based on the current MPF;
responsive to the scale parameter having a value beyond a threshold of an estimate interval:
modifying the current MPF to represent the portion of the visual data and the portion of the inertial data that are represented by the intermediary MPF,
modifying the intermediary MPF to represent the set of the visual data that is represented by the visual MPF and to omit representation of the set of the inertial data that is omitted by the visual MPF, and
modifying the scale parameter based on the modified current MPF;
determining additional values for the modified scale parameter based on the modified current MPF;
determining, based on the modified scale parameter, one or more positional parameters; and
providing the one or more positional parameters to an autonomous system.

8. The method of claim 7, wherein the dynamic marginalization module is further configured for, responsive to the scale parameter having a first value beyond a midline threshold, modifying the intermediary MPF to represent the set of the visual data that is represented by the visual MPF

9. The method of claim 7, further comprising modifying, responsive to the scale parameter having the value beyond the threshold of the estimate interval, the threshold of the estimate interval.

10. The method of claim 7, further comprising:
receiving the set of inertial data from an inertial measurement unit (IMU); and
determining the set of visual data based on camera frame data received from at least one camera sensor.

11. The method of claim 7, further comprising:
minimizing an energy function based on the current MPF; and
determining, based on the minimized energy function, a bundle adjustment to the one or more positional parameters.

12. The method of claim 7, wherein the set of inertial data includes a transformation parameter describing a scale value and a gravity direction value.

13. A non-transitory computer-readable medium embodying program code for initializing a visual-inertial odometry system, the program code comprising instructions which, when executed by a processor, cause the processor to perform operations comprising:
receiving, during an initialization period, a set of inertial measurements, the inertial measurements including a non-initialized value for multiple inertial parameters;
receiving, during the initialization period, a set of camera frames, the set of camera frames indicating a non-initialized value for multiple visual parameters;
determining, in a joint optimization, an inertial error of the set of inertial measurements and a photometric error of the set of camera frames, wherein the joint optimization includes:
generating an IMU factor that describes a relation between the multiple inertial parameters,
generating a visual factor that describes a relation between the multiple visual parameters, and
minimizing a combination of the inertial error and the photometric error, wherein the inertial error and the photometric error are combined based on the relation described by the IMU factor and the relation described by the visual factor;
determining, based on the photometric error and the inertial error, respective initialized values for each of the multiple inertial parameters and the multiple visual parameters; and
providing the initialized values to an autonomous system.

14. The non-transitory computer-readable medium of claim 13, wherein:
the multiple inertial parameters include a gravity direction, a velocity, an IMU bias, a scale, or a combination thereof, and
the multiple visual parameters include a pose, a point depth, or a combination thereof.

15. The non-transitory computer-readable medium of claim 13, wherein the initialized values include at least an initialized pose, an initialized gravity direction, and an initialized scale.

16. The non-transitory computer-readable medium of claim 13, wherein minimizing the combination of the inertial error and the photometric error is based on a Gauss-Newton optimization.

17. The non-transitory computer-readable medium of claim 13, wherein the non-initialized values in the set of inertial measurements are based on at least one accelerometer measurement, a default value, or a combination thereof.

18. The non-transitory computer-readable medium of claim 13, wherein the joint optimization further includes determining a bundle adjustment of the multiple inertial parameters and the multiple visual parameters.

19. The non-transitory computer-readable medium of claim 13, wherein the IMU factor and the visual factor are generated based on one or more marginalization prior factors, wherein each marginalization prior factor (MPF) represents data from the set of inertial measurements or the set of camera frames.

20. The non-transitory computer-readable medium of claim 13, wherein minimizing the combination of the inertial error and the photometric error is based on a minimization of an energy function.
